(19) United States
(12) Patent Application Publication
(10) Pub. No.: US 2006/0047594 A1
(43) Pub. Date: Mar. 2, 2006

(54) Circle Chain Contract

(76) Inventor: Fredrick David Haase, Anchorage, AK (US)

Correspondence Address: Fredrick David Haase, PMB 587, 200 West 34th, Anchorage, AK, 99503, US

(21) Appl. No.: 10/726,843

(22) Filed: Aug. 30, 2004

(51) Int. Cl. G06Q 40/00

(52) U.S. Cl. 705/37

(57) ABSTRACT

A Circle Chain Contract is a tool a producer/owner of goods or services can use to trade their product/property at market value for goods or services instead of paying cash. Consider a carousel surrounded by people with packages as it rotates; people place a package on it and remove a package. The beginning is the packaging of products and services. Like the inventory of a supermarket, packaging contains the details of a contract: choose the item you want, deliver it to the checkout stand, pay the price and it is yours. Packaging for a trade includes who pays for delivery, where from and when, along with other pertinent features: description, quality, quantity and sizzle. A chain of 12 separate offers of specific packages each having two additional offers provides the first party 35 individual packages to choose from. Packages are displayed, offers communicated and contracts generated through the internet.

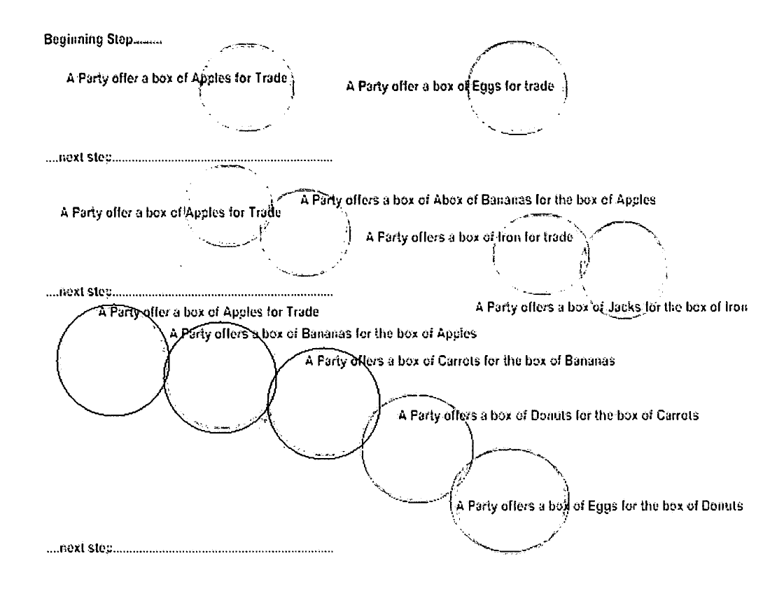

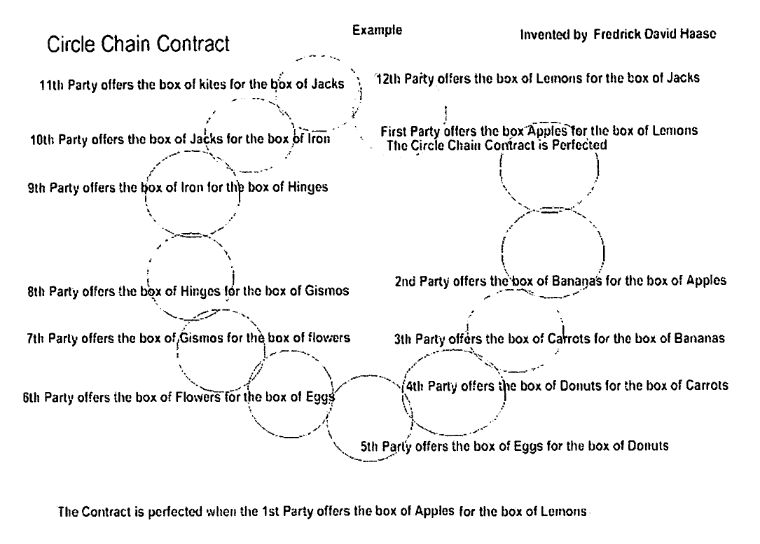

A “Circle Chain” Contract is a method allowing multiple parties to easily contract with each other for the exchange of goods and services in one contract without the use of intermediate property.

A Circle Chain Contract becomes effective when the first party offers to the last party. The parties are then sequenced by number; first, second, third, fourth, fifth, and so on. Before becoming effective, any of the parties have the opportunity to be the first party.

In this sample the parties offer as follows:
1. Offers a box of Apples for something, starts looking for that something within the forum.
2. Offers a box of Bananas for the box of Apples.
3. Offers a box of Carrots for the box of Bananas.
4. Offers a box of Donuts for the box of Carrots.
5. Offers a box of Eggs for the box of Donuts.
6. Offers a box of Flowers for the box of Eggs.
7. Offers a box of Gizmos for the box of Flowers.
8. Offers a box of Hinges for the box of Gizmos.
9. Offers a box of Iron for the box of Hinges.
10. Offers a box of Jacks for the box of Iron.
11. Offers a box of Kites for the box of Jacks.
12. Offers a box of Lemons for the box of Kites.
   When the first party offers the box of Apples for the box of Lemons, the contract is perfected, the circle of offers is complete.

Pizzazz can be added or subtracted by “will adds” or “taxing”. “Will adds” are for the benefit of the first party, as a incentive to be the first party. In this example, the first party gets the box of lemons and all the bags of goodies. Pizzazz can be decreased by “taxing”, each party has to give up an item from his box. Pizzazz can also be a combination of both in it's effect on the dynamics of a Circle Chain Contract. Could be compared to the quality of the fuel in an internal combustion engine.

### EXAMPLE

If each party's offer of a box of something also contains a “will add” bag of goodies (the Pizzazz can be set for different beneficiaries) in this example the first party gets all the goodies. The goodies make the lemon sweet, so to speak. If only a couple of parties added a bag of goodies, that would be less Pizzazz than if six parties included a box of goodies. If all the parties added a bag of goodies the first party would get a box of Lemons and 11 bags of goodies. The other parties would get the box of what they agreed to take in their offer.

An acceptance in a Circle Chain Contract is not needed to be complete, but it is needed to be legal. Basic contract law teaches that two essentials of any contract are an offer and an acceptance and without them both you cannot have a contract. The first party can simply offer the box of Apples for the Lemons, making a circle of offers complete. Each party gets what they offered to receive and the contract is complete when the first party offers his package for the last package offered in the chain, thus making the circle complete. From a legal standpoint, the first party accepts the other 11 parties' offers.

If the party with the box of Donuts offers for the box of Kites, prior to the box of Apples being offered for the box of Lemons, then the party offering the box of Donuts would be the first party and the party offering the box of Kites the last party. The parties with the Apples, Bananas and Carrots would become a chain of offers (a potential contract). There would not be any Kites for the party with the Lemons to offer for. An offer for the box of Apples for the box of Lemons at this time would not complete the Circle Chain Contract.

The advantage of a Circle Chain Contract is that you do not need a third type of property (like cash, credit or gold, etc) as a go-between to get what you want. You simply make an offer of what you have for what you want. If enough parties make enough offers you will get what you want, assuming offers are made for other packages of similar values. Prices are not needed, however, the offering party's value as part of the description of the package can be helpful but is not a part of the Circle Chain Contract. Offers of lower values will never link because each party makes their own judgment of value; in theory a lowball offer would need a highball offer in order to complete the Circle Chain Contract between value minded parties.

To use a Circle Chain Contract effectively, a facilitator or registrar is needed, but not absolutely necessary; the problem is communications; how does everyone who makes an offer know what other offers are in the chain at any given time? Therefore, a facilitator is practical.

When the first offer is made, a taker is established and a chain is started. As more offers are made, either more chains are started or more links to previously started chains are added. When any link in the chain becomes a taker for a following offer, that offer becomes the last link in the chain, the circle is complete, thus the contract is complete. If the first party offered to the second party, and the second party accepted it, that would be an ordinary contract, as there are no other links and a circle does not exist.

The parties first offer their packaged property for trade in a forum, then they offer their packaged property for other people's packaged property that has been offered in the same forum, as others make offers for their packaged property. When the first offer is made a taker/beneficiary is established and a chain is started. As more offers are made either more chains are started or more links to previously started chains are added. When any link in the chain becomes a taker for the last link in the chain the circle is complete and the contract is perfected. The more parties and offers, the greater the possibilities. When a contract is perfected all other offers made by the party's using the same package in other offers outside of the Circle Chain Contract are withdrawn. If they had more than one package, they would probably want to make more offers, which would involve a new, separate Circle Chain Contract.

The use of computers and scripts (artificial intelligence, backend graphing with molecular structure, automated file and mail servers) are used to track and communicate the numerous possible contracts, identify and deliver in real time the possible and the perfected contracts to the parties via the intent.

The possible uses for the Circle Chain Contract method are numerous. The Barter Industry is the most obvious, but there are other uses such as equipment sharing among contractors. The contractor offers certain equipment for use during a specific time period for the use of another contractor's certain equipment during a specific time period, resulting in more efficient use of equipment; thus a contractor could bid lower.

The requested Patent is for the exclusive right to facilitate, register, advertise or in any way solicit offers for property (real or personal), goods and services with the intent of linking them in a chain of circles, for the statutory period of time.

Circle chain contract invented November 2003 by Fredrick David Haase

1. The circle chain contract is a unique way of trading goods and services between three or more parties without the use of an intermediate asset such as cash, gold or barter credit.
The chaining of packages by making offers of one package for another results in an increase of possibilities that any given participant is offered an acceptable package. This chaining of packages by contract to take advantage of the exponential increase in the possibility of an acceptable package is the basic foundation of the invention.
The protections provided by a patent are needed to develop the product and educate the market.
The widespread use of this concept will make industry more efficient.
